(19) United States
(12) Patent Application Publication
(10) Pub. No.: US 2011/0058906 A1
(43) Pub. Date: Mar. 10, 2011

(54) METHOD AND APPARATUS FOR CONVEYING BAGGED PRODUCTS

(76) Inventor: Timothy J.B. Moulsdale, Bourne End Buckinghamshire (GB)

(21) Appl. No.: 12/867,483

(22) PCT Filed: Feb. 16, 2009
(86) PCT No.: PCT/GB2009/050143

§ 371 Date: Nov. 22, 2010

(30) Foreign Application Priority Data
Feb. 15, 2008 (GB) 0802812.8

(51) Int. Cl. B65G 51/26

(52) U.S. Cl. 406/147; 406/108

(57) ABSTRACT

An apparatus and method are provided for conveying bags containing a product, for example bags of crisps or other snack food. The apparatus comprises an elongate flexible tube, for example of a fabric-based material, along which air is caused to flow. The bags are introduced into the flexible tube at a first location so that they are carried along by the air flow from the first location to a second location, where they are removed from the air flow.

This invention relates to a method and apparatus for conveying bagged products. In particular, it is concerned with a method and apparatus for conveying bags, typically consisting of or comprising a plastics film, containing a food product, for example a snack food product such as potato crisps.

A variety of methods are used to convey such bags within a plant where they are packed, and one such method uses an air conveyor. This takes the form of an elongate metal duct, typically of stainless steel, within which air flows from an upstream end to a downstream end. In such an air conveyor the bags are carried by the flow of air from the upstream end to the downstream end.

It has been found, however, that problems can arise in such an air conveyor as a result of impacts between the bags and the duct walls, particularly where the path of the duct takes it round a bend. It has been found that such impacts sometimes cause product within a bag to strike the bag wall sufficiently hard as to cause the bag wall to be punctured. It must be borne in mind that the plastics material of which such bags are made, normally polypropylene, is very thin, typically around 30 μm, and some products, for example crisps, can have sharp edges and corners.

It is an object of the present invention to provide a method and apparatus for conveying bagged products, using an air flow, which avoids, or at least mitigates, the problem just described.

According to the present invention there is provided an apparatus for conveying bags containing a product, the said apparatus comprising means defining a flow path for air, the said means comprising an elongate flexible tube, means for causing air to flow along the said flow path, means for introducing the said bags into the flow path at a first location so that they are carried along by the air flow from the first location to a second location, and means for removing the bags from the flow path at the second location.

The invention further provides a method of conveying bags containing a product from a first location to a second location, wherein an apparatus is employed which is according to the invention.

In other aspects the invention may further provide means, as set out in the dependent claims hereof, for introducing bags into a flow path, and means for removing bags from a flow path.

In the accompanying drawings, which illustrate an embodiment of an apparatus according to the invention:

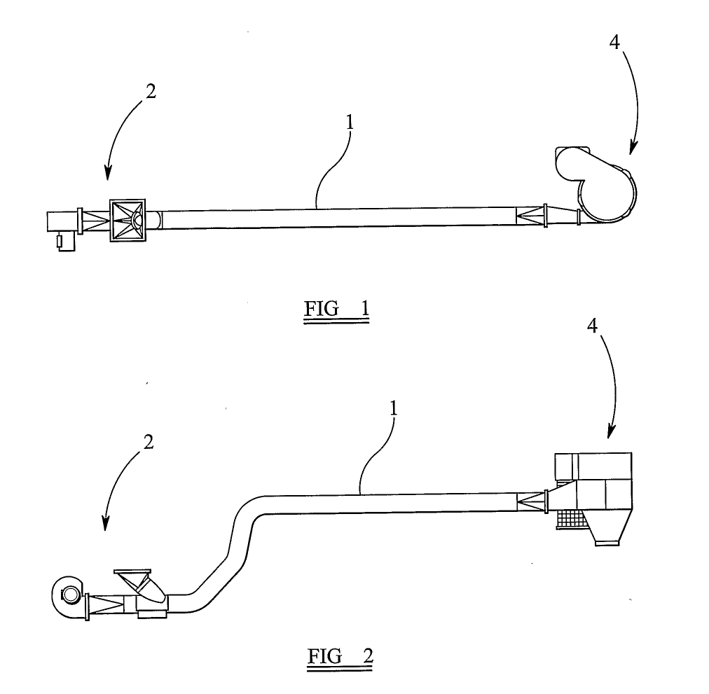

FIG. 1 shows a complete conveying apparatus from above;

FIG. 2 shows the apparatus of FIG. 1 in a side view;

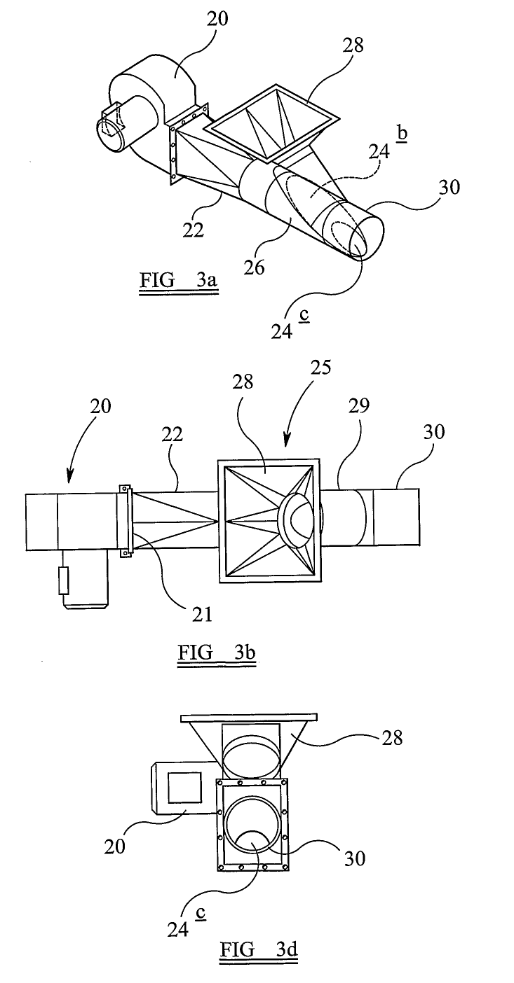

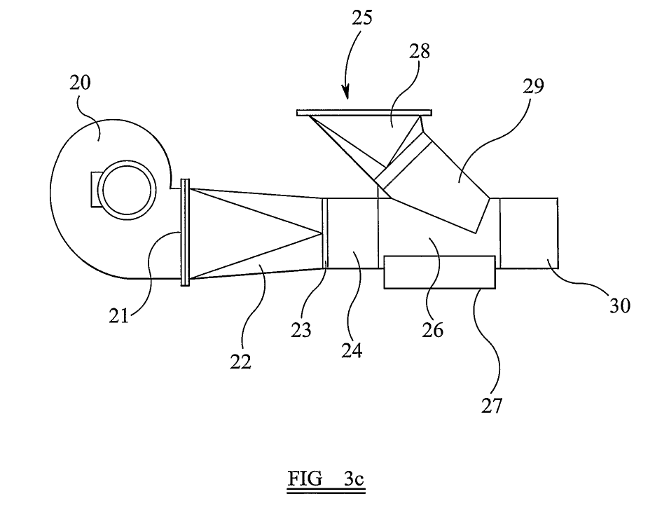

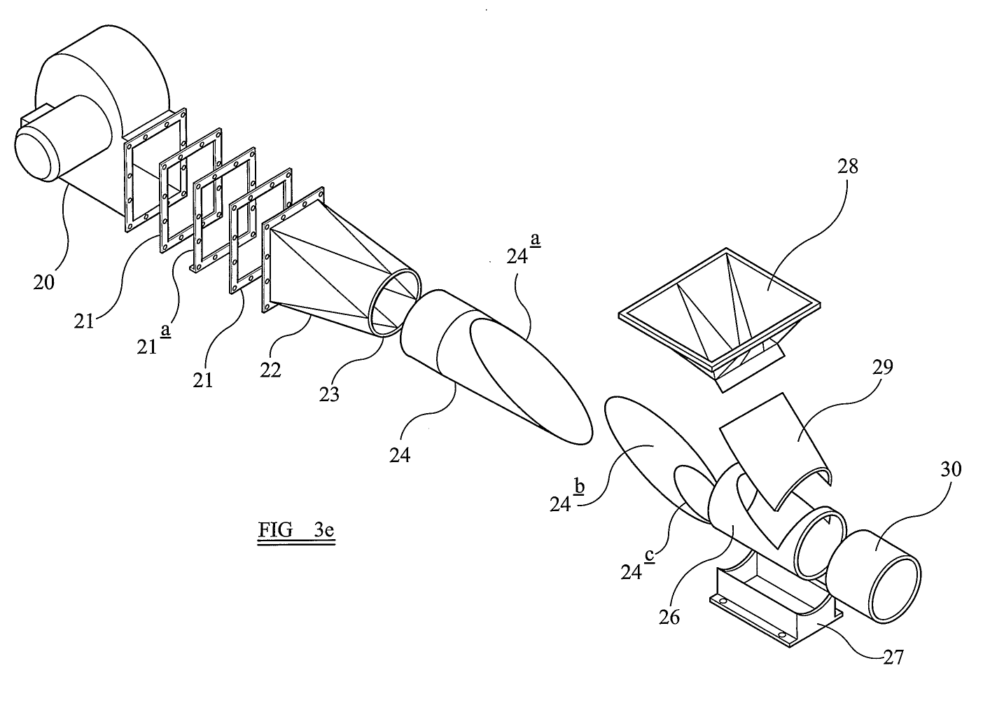

FIGS. 3a to 3e show, in more detail, the device at the upstream end of the conveyor for introducing bags into the air flow, the figures being, respectively, a perspective view, a plan view, a side elevation, an end elevation and an exploded perspective view; and

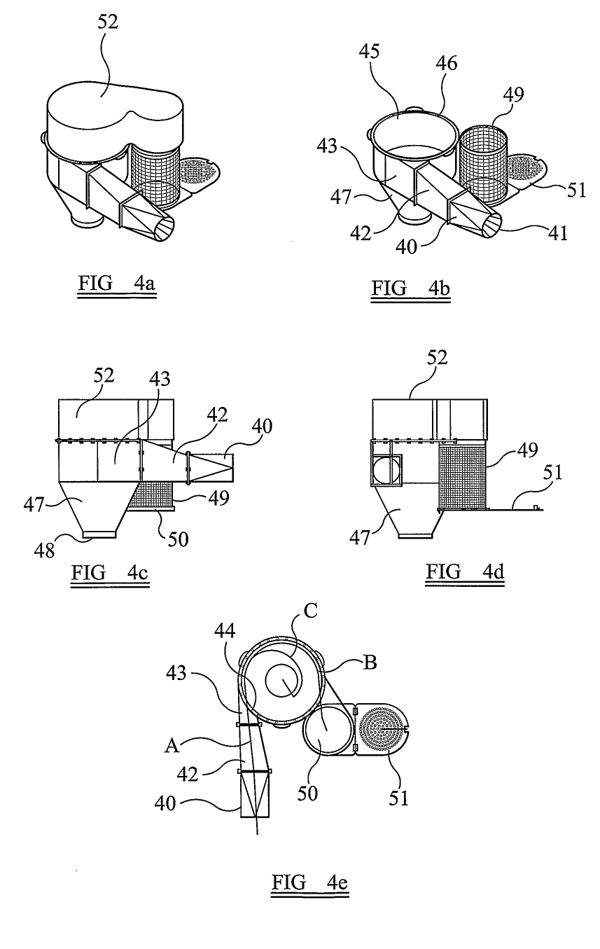

FIGS. 4a to 4e show, in more detail, the arrangement at the downstream end of the conveyor for extracting the bags from the air flow, the figures being respectively a perspective view, a perspective view with a portion removed to show the interior, a side elevation, an end elevation and a view from above with various flow paths (described in detail below) superimposed thereon.

Referring first to FIGS. 1 and 2, these show a conveying tube 1 formed of a flexible material. From the point of view of its use it is preferred to form the tube as a single, integral entity. However, it is alternatively possible for the tube to be formed of a plurality of segments joined end to end. The segmented construction may provide for easier manufacture, as it enables individual segments to be formed by relatively simple means, and then joined together to produce a tube which can follow any desired route, however tortuous, much in the same manner as sections of cloth are joined together to produce the three dimensional shape required, for example, by an article of clothing. A segmented tube formed in this way for the purposes of the present invention should preferably have those portions which lie distally of any seam, on the outside of the tube, i.e. the reverse of what is the case with a finished garment, so that bags passing through the tube cannot contact those portions and thereby risk being damaged by them. The tube shown is of circular cross-section, though some other cross-section could be used instead. Conveniently the tube has a diameter of from 250-350 mm, though the diameter could be more or less than these values if desired.

The tube can be formed of any suitable flexible material which is appropriate having regard to the nature of the bags which are to be conveyed and having regard to the velocity and pressure of the air within the tube. Thus, the tube can be made, for example, of a fabric, preferably a woven fabric, such as a fabric used for the manufacture of the sails of a sailing boat, provided the fabric is, or is rendered, sufficiently resistant to air flow through its walls to ensure that substantially all the air which enters at the upstream end of the tube reaches the downstream end. In one possible form of construction a tube of fabric material is lined with a web of air-impervious material, for example a web of air-impervious plastics material.

The conveying tube 1 is connected at its upstream end to an apparatus 2 for generating an air flow and introducing bags into that air flow, and is connected at its downstream end to an apparatus 4 for extracting the bags from the air flow. At its upstream end the tube 1 can simply be mounted over an outlet duct of the apparatus 2. At its downstream end simply mounting the tube around an inlet duct of the apparatus 4 is not, by itself, normally desirable, since bags leaving the downstream end of the tube may then strike the upstream end of the inlet duct of the apparatus 4 with consequent damage to the bags. Accordingly, at its downstream end the tube 1 is preferably provided with an interior sleeve (not shown), which passes inside the upstream end of the inlet duct, and which avoids this problem.

The apparatus 2 will now be described in more detail with reference not only to FIGS. 1 and 2 but also to FIGS. 3a to 3e. The apparatus is shown as comprising a blower 20, which can be of conventional construction, having a square cross-section outlet connected via gaskets 21 and a support 21a to a square-to-round pipe section 22 which, as its name implies, has a square cross-section inlet and a circular cross-section outlet. The outlet is denoted in the drawings by reference numeral 23. The outlet 23 of the square-to-round pipe section 22 is connected to a venturi inlet tube 24 of a bag-feeding arrangement 25. The tube 24 has an elliptical outlet 24a which is partially closed by an inclined cover 24b having a cut-out 24c. The feeding arrangement 25 further comprises a duct 26 mounted on a support 27, and a bag infeed chute 28 which leads, beneath a cover 29 to the interior of the duct 26. The downstream end of the duct section 26 is connected to an outlet duct 30, and the flexible tube 1 is, as already indicated, mounted at its inlet end around the outside of this duct, in an air tight manner.

At its downstream end the conveying tube 1 is connected, as already indicated, to an apparatus 4 for extracting the bags from the air flow. The apparatus 4 comprises a round-to-square inlet duct 41 followed by a square-to-rectangular duct 42. The outlet end of the latter communicates with a duct 43 which leads to an inlet 44 of a chamber 45. The chamber 45 has a cylindrical upper portion 46 and a frustoconical lower portion 47, the latter being provided at its lower end with an outlet 48. Thus, the chamber has a generally circular cross-section defined by a wall surrounding a central, vertical axis, with an entry port for allowing air and bags carried thereby to enter in a direction generally tangential to the said wall, a first exit (the outlet 48) in a downward direction along the central axis, and a second exit (the upper end of the cylindrical portion 46) in an upward direction along the central axis.

To one side of the chamber 45 is a cylindrical basket 49 so made that its cylindrical wall is pervious to air. This may conveniently be achieved by forming the cylindrical wall of a wire mesh or of a perforated sheet material. The lower end of the basket defines an outlet 50 which is closable by an air-permeable lid 46. This is shown in FIGS. 4a to 4e in a position in which the lid has been pivoted away from the lower end of the basket 49 so as to leave that lower end open. When pivoted through 180° the lid 51 closes the lower end of the basket.

The upper ends of the chamber 45 and basket 49 are interconnected by a hollow top section 52 as visible in FIGS. 1 and 2 and in FIGS. 4a, 4c and 4d. The top section 52 has been omitted from FIGS. 4b and 4e to enable the interior of the apparatus 4 to be seen.

The operation of the air conveyor is as follows. An air flow is generated through the tube by means of the blower 20, and typically the air velocity would be in the region of 7 to 15 m/s. With an air velocity in this range, and a tube diameter of 250-350 mm, it is typically possible, by way of example, to convey several hundred bags, say 400-600, each having a weight of 25 g. Sealed bags of product, for example sealed bags of crisps, are fed into the upper end of the infeed chute 28, and slide down the inclined cover 24b, from where the venturi effect created in the duct section 26 by the air flowing out of the venturi inlet tube 24 causes the bags to be sucked into the air flow. The bags are carried by that air flow along the conveyor tube 1. Because the tube 1 is made of a flexible material, it is able to give when struck by bags, an effect which occurs particular at bends in the duct, and there is therefore a reduced likelihood of such impacts causing the product in a bag to puncture the wall of that bag.

At the downstream end of the tube the bags are carried by the air flow into the apparatus 4. Referring particularly to FIG. 4e, the general direction of flow of both bags and air, as these enter the apparatus 4 is indicated by line A. Inlet 44 into the chamber 45 directs the flow into the chamber in a direction which is tangential to the cylindrical wall thereof, so that the flow of both bags and air initially follows the wall. However, the flow then splits into two components, as shown in FIG. 4e. Line B represents the direction of travel of most of the air, perhaps 90% of it, together with any very light items being carried by the air. These light items would include any bags which were empty, either because they had not been filled in the first place, or because they had become broken at some stage and lost their contents, together with the contents of any bags which, despite the use of a flexible conveying tube, had broken during the course of conveyance. Line C represents the motion of the remainder of the air, perhaps 10%, together with all the heavier items, i.e. filled bags.

While bags are being conveyed the lid 51 is in its closed position, so that although air entering the basket 49 can flow out of it through the cylindrical wall of the basket and through the apertures in the lid 51, light items carried by that air remain trapped within the basket. The basket and its lid thus act a filter to trap light items carried by the air flow. The basket can be emptied from time to time, as need arises, by opening the lid 51. The filled bags pass out of the apparatus 4 through the opening 48 and thence to whatever further stage is being supplied by the air conveyor. This could, for example, be a further packing stage, at which a number of individual bags are put together into a larger bag to form a multipack. It should be understood, however, that the opening 48 could feed any subsequent stage to which the bags might require to be fed. Thus, other uses of the air conveyor include conveying bags to a store room and conveying bags to the inlet of a weighing machine. The path of the air conveyor may be horizontal, or substantially horizontal, or the air conveyor may be used to elevate bags or to transport them to a lower location.

Various modifications may be made to the embodiment described above. One of these is to use a conveyor tube which has at least one section of flexible material, and at least one section of rigid material, for example stainless steel. The flexible sections could, for example, be used only to provide non-linear sections, where the risk of damage to the bags was greatest. However, such a modification has at least two potential disadvantages. One is the risk of damage to bags at the junctions between the flexible and non-flexible sections, and the other is an increase in cost, at least compared to an all-flexible duct. Another modification, which is especially appropriate where the duct is of a fabric material, is to sew on the duct, at intervals along its length, tags which can then be used to support the duct on one or more rigid support members. This ensures that the duct is held in an orderly manner both when no air is flowing along it (when it could otherwise simply fall down) and when air is flowing along it (when it might otherwise swing around or wobble).

1. An apparatus for conveying bags containing a product, the said apparatus comprising means defining a flow path for air, the said means comprising an elongate flexible tube, means for causing air to flow along the said flow path, means for introducing the said bags into the flow path at a first location so that they are carried along by the air flow from the first location to a second location, and means for removing the bags from the flow path at the second location.

2. An apparatus according to claim 1, wherein the means defining the flow path are constituted substantially wholly by the flexible tube.

3. An apparatus according to claim 1 or 2, wherein the flexible tube is formed of a plurality of segments joined end to end.

4. An apparatus according to any preceding claim, wherein the flexible tube comprises a fabric.

5. An apparatus according to claim 4, wherein the fabric is a woven fabric.

6. An apparatus according to claim 4 or 5 wherein the fabric is lined with a web of air-impervious material.

7. An apparatus according to any preceding claim wherein at least one rigid support is provided for the tube, and the tube is provided with a plurality of tags arranged along the length thereof, by which the tube is supported by the said at least one rigid support.

8. An apparatus according to any preceding claim, wherein the means for introducing the bags into the flow path comprises a blower for generating an air flow though a venturi section, and an introduction chute for enabling the bags to enter the venturi section.

9. An apparatus according to any preceding claim, wherein the means for removing the bags from the flow path comprises a chamber having a generally circular cross-section defined by a wall surrounding a central axis, with an entry port for allowing air and bags carried thereby to enter in a direction generally tangential to the said wall, a first exit for bags having product therein, the said first exit being in one direction along the central axis, and a second exit for lighter objects, the said second exit being in the opposite direction along the central axis.

10. An apparatus according to claim 9, wherein the said second exit communicates with a filter which retains lighter objects but allows air to pass therethrough.

11. An apparatus according to claim 9 or 10, wherein the said second exit includes an openable lid which, when opened, allows the removal of lighter objects retained by the filter.

12. An apparatus according to any one of claims 9 to 11, wherein the chamber comprises a cylindrical portion into which the entry port opens, and a frustoconical portion having a larger diameter end connected to the cylindrical portion, and a smaller diameter end defining the said first exit.

13. An apparatus according to any one of claims 9 to 12, wherein the said central axis is substantially vertical, with the said first exit being downwards and the second exit being upwards.

14. A method of conveying bags containing a product from a first location to a second location, wherein an apparatus is employed which is according to any preceding claim.

15. A method according to claim 14, wherein the product in the bags is a food product.

16. A method according to claim 15, wherein the food product is a snack food product.
